(19) United States
(12) Patent Application Publication
(10) Pub. No.: US 2019/0100261 A1
(43) Pub. Date: Apr. 4, 2019

(54) TRAILER JACK-KNIFE PREVENTION SAFETY DEVICE

(71) Applicant: Roy A. Hansen, Fort Collins, CO (US)

(72) Inventor: Roy A. Hansen, Fort Collins, CO (US)

(21) Appl. No.: 15/724,338

(22) Filed: Oct. 4, 2017

(51) Int. Cl. B62D 53/08; B60D 1/01; B60D 1/30

(52) U.S. Cl. CPC B62D 53/0871; B60W 2520/10; B60D 1/30; B60D 1/015

(57) ABSTRACT

A trailer jack-knife prevention safety device automatically deploys over a threshold speed to physically inhibit jack-knifing of a trailer. The device includes an actuator coupled to a trailer. A trailer speed sensor is operationally coupled to the actuator for detecting a speed of the trailer. The trailer speed sensor activating the actuator to extend a pin when the trailer is traveling faster than a threshold speed and deactivates the actuator wherein the pin is retracted when the trailer is traveling slower than the threshold speed. When extended, the pin limits pivoting of the trailer relative to the vehicle to inhibit jack-knifing of the trailer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety devices and more particularly pertains to a new safety device for being automatically deployed over a threshold speed to physically inhibit jack-knifing of a trailer.

### BRIEF SUMMARY OF THE INVENTION

An embodiment of the disclosure meets the needs presented above by generally comprising an actuator coupled to a trailer. A trailer speed sensor is operationally coupled to the actuator for detecting a speed of the trailer. The trailer speed sensor activating the actuator to extend a pin when the trailer is traveling faster than a threshold speed and deactivates the actuator wherein the pin is retracted when the trailer is traveling slower than the threshold speed. When extended, the pin limits pivoting of the trailer relative to the vehicle to inhibit jack-knifing of the trailer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a trailer jack-knife prevention safety device according to an embodiment of the disclosure.

FIG. 2 is a top perspective view of an embodiment of the disclosure.

FIG. 3 is a cross-sectional view of an embodiment of the disclosure taken along line 3-3 of FIG. 1.

FIG. 4 is a left side view of an embodiment of the disclosure.

FIG. 5 is a cross-sectional view of an embodiment of the disclosure taken along line 5-5 of FIG. 3.

### DETAILED DESCRIPTION OF THE INVENTION

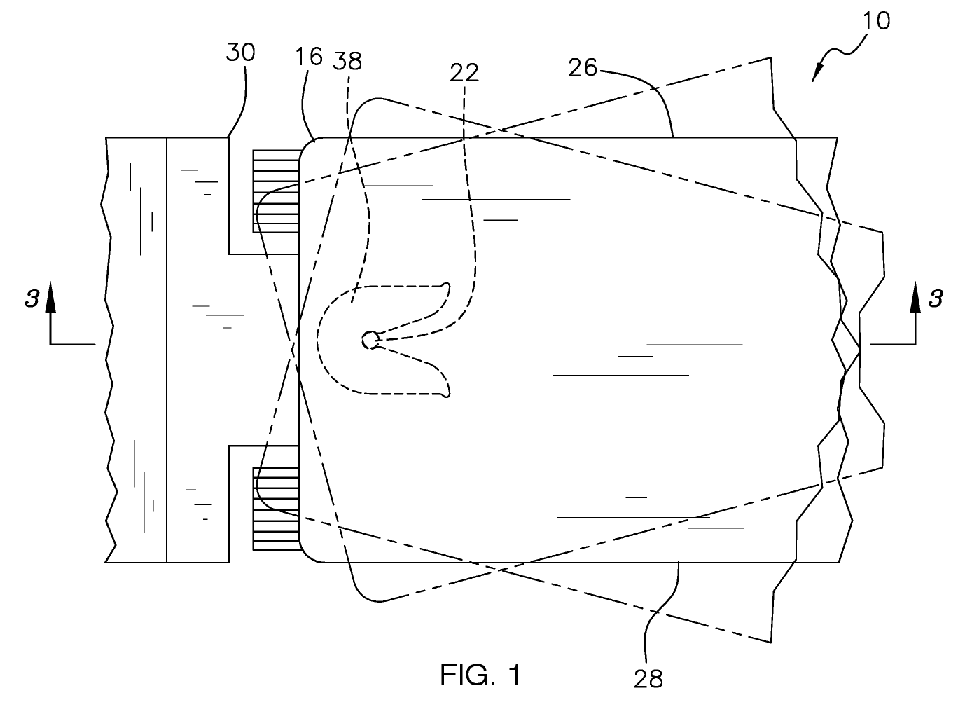

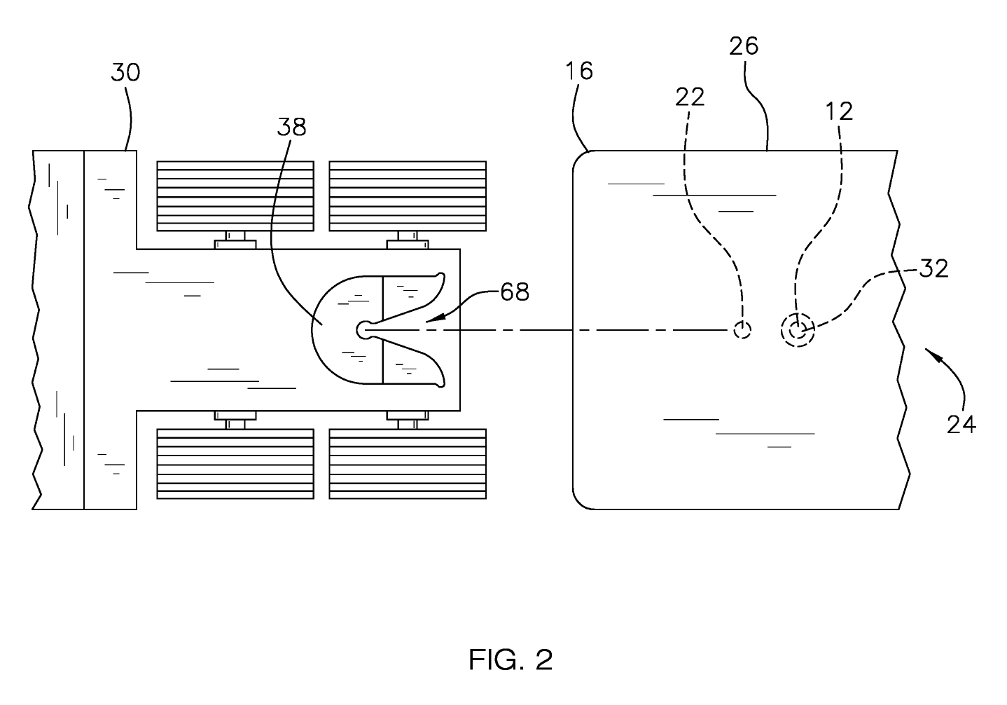

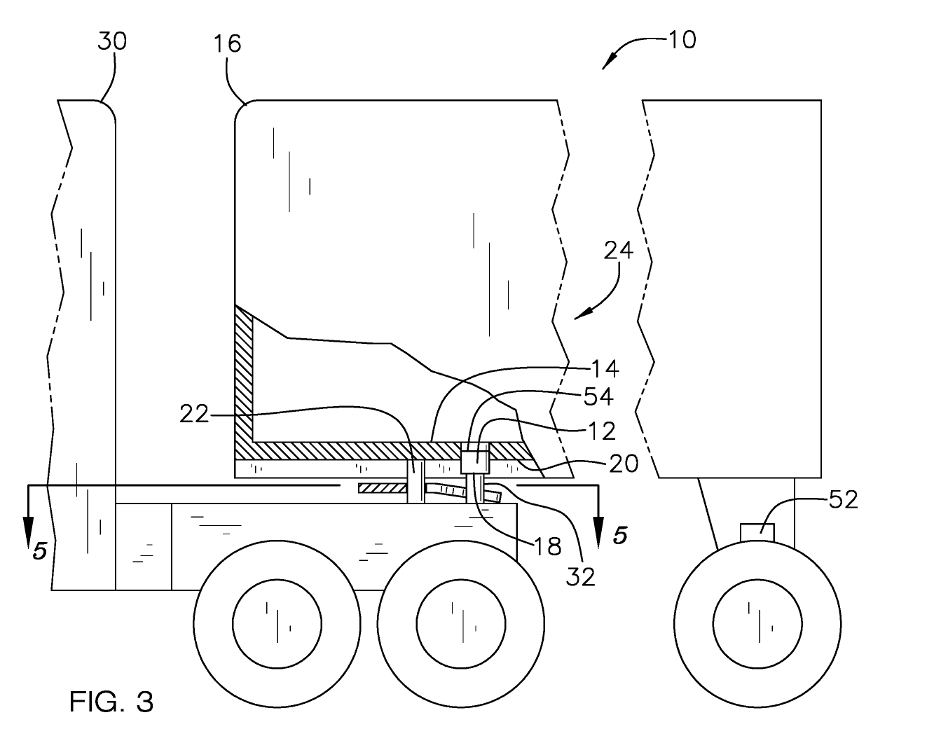

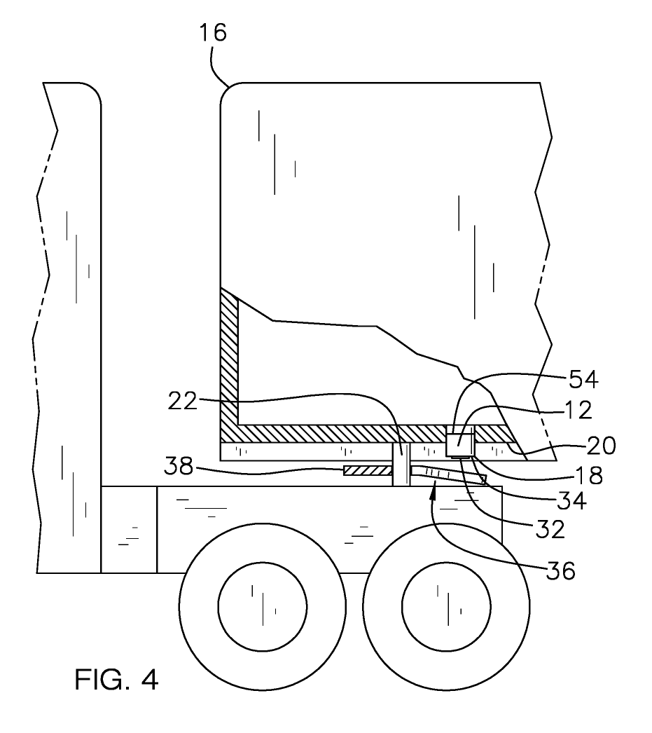

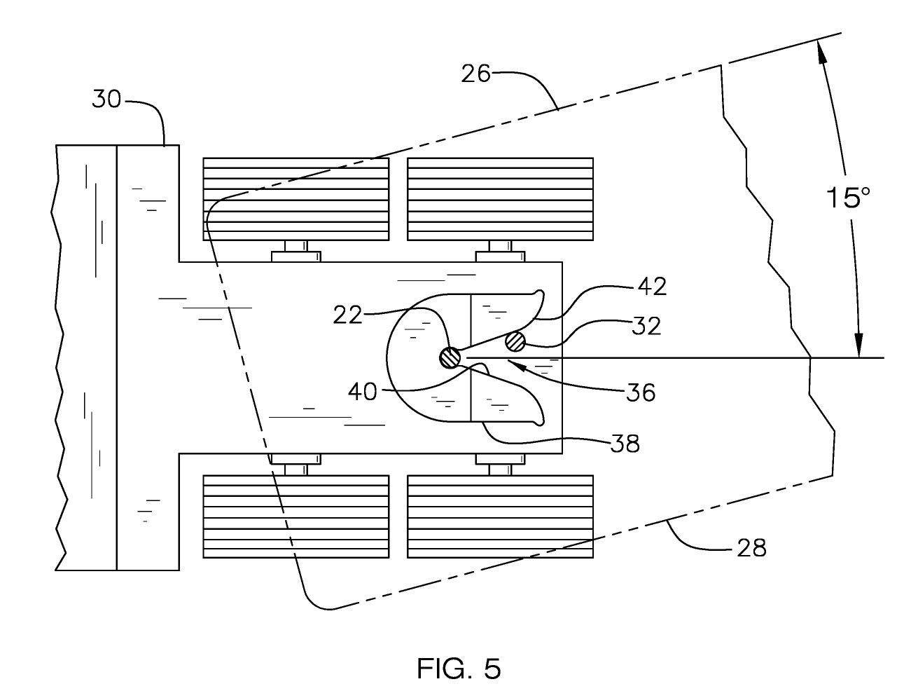

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the trailer jack-knife prevention safety device 10 generally comprises an actuator 12 coupled to a bottom wall 14 of a trailer 16 such that the actuator 12 is positioned in a static position relative to and proximate a king pin 22 on the trailer 16. The actuator 12 extends upwardly into the bottom wall 14 of the trailer 16 such that a bottom 18 of the actuator 12 is positioned below a bottom surface 20 of the bottom wall 14 of the trailer 16. The actuator 12 is positioned closer to the king pin 22 than a rear 24 of the trailer 16. The actuator 12 is also centrally positioned with respect to a first lateral side 26 and a second lateral side 28 of the trailer 16. The actuator 12 may be powered by connection to an electrical system of a vehicle 30 or an independent power source such as a battery or the like coupled to the trailer 16.

A pin 32 is operationally coupled to the actuator 12 wherein the pin 32 is selectively extendable from the trailer 16 to engage a fifth wheel 38 on the vehicle 30. The pin 32 is centrally positioned with respect to the first lateral side 26 and the second lateral side 28 of the trailer 16. The pin 32 is movably coupled to the actuator 12 such that the pin 32 is positionable in an extended position when the actuator 12 is activated wherein the pin 32 is extended downwardly away from the trailer 16 past the bottom 18 of the actuator 12 to position the pin 32 within a tapered slot 68 of a king pin space 36 of the fifth wheel 38 on the vehicle 30 such that the pin 32 is restricted by opposite edges 70 defining the tapered slot 68. Thus, pivoting of the trailer 16 about the king pin 22 relative to the fifth wheel 38 is inhibited. The pin 32 is positionable in a retracted position when the actuator 12 is deactivated wherein the pin 32 retracts such that a bottom 34 of the pin 32 is positioned clear of the fifth wheel 38 to allow free pivoting of the trailer 16 relative to the fifth wheel 38. The pin 32 may have a length between 10 cm and 15 cm.

A trailer speed sensor 50 is operationally coupled to the actuator 12. The trailer speed sensor 50 is configured for detecting a speed of the trailer 16. The trailer speed sensor 50 activates the actuator 12 to extend the pin 32 when the trailer 16 is traveling faster than a threshold speed. The trailer speed sensor 50 deactivates the actuator 12 wherein the pin 32 is retracted when the trailer 16 is traveling slower than the threshold speed. The threshold speed may be set or determined as desired to allow for full mobility at lower speeds where jack-knifing is not an imminent concern. The pin 32 is deployed at higher speeds where an angle of the fifth wheel 38 relative to the trailer 16 is less than the angling within the tapered slot 68 of the king pin space 36 during safe movement of the vehicle 30 and trailer 16. The threshold speed may be between 15 and 25 miles per hour (24 km/hr and 40 km/hr). More specifically, the threshold speed may be 20 miles per hour (32 km/hr). The trailer speed sensor 50 may include a wheel speed sensor 52 positioned proximate a wheel 54 of the trailer 16. A receiver 54 is coupled to the actuator 12. The wheel speed sensor 52 is communicatively coupled to the receiver 54. The wheel speed sensor 52 may be wirelessly communicatively coupled to the receiver 54.

In use, the actuator 12 is coupled to the trailer 16 to automatically extend the pin 32 over the threshold speed and retract the pin 32 below the threshold speed. Thus, jack-knifing of the trailer 16 relative to the vehicle 30 is substantially inhibited while traveling at speeds in which jack-knifing is a concern but the vehicle 30 and trailer 16 remain fully capable of turning and maneuvering at lower speeds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trailer safety assembly comprising:
an actuator coupled to a trailer such that said actuator is positioned in a static position relative to and proximate a king pin on the trailer;
a pin operationally coupled to said actuator wherein said pin is selectively extendable from said trailer to engage a fifth wheel on a vehicle, said pin being positionable in an extended position when said actuator is activated wherein said pin is extended downwardly away from said trailer past a bottom of said actuator to position said pin within a tapered slot of a king pin space of said fifth wheel on said vehicle such that said pin is restricted by opposite edges defining said tapered slot of said king pin space of said fifth wheel and pivoting of said trailer about said king pin relative to said fifth wheel is inhibited, said pin being positionable in a retracted position when said actuator is deactivated wherein said pin retracts wherein a bottom of said pin is positioned clear of said fifth wheel to allow free pivoting of said trailer relative to said fifth wheel; and
a trailer speed sensor operationally coupled to said actuator, said wheel speed sensor being configured for detecting a speed of said trailer, said trailer speed sensor activating said actuator to extend said pin when said trailer is traveling faster than a threshold speed, said trailer speed sensor deactivating said actuator wherein said pin is retracted when said trailer is traveling slower than said threshold speed.

2. The assembly according to claim 1 further comprising said actuator being coupled to a bottom wall of the trailer wherein said actuator extends upwardly into the bottom wall of the trailer wherein a bottom of said actuator is positioned below a bottom surface of the bottom wall of the trailer.

3. The assembly according to claim 1 further comprising said actuator being positioned closer to the king pin than a rear of the trailer.

4. The assembly according to claim 1 further comprising said pin being centrally positioned with respect to a first lateral side and a second lateral side of the trailer.

5. The assembly according to claim 1 further comprising said pin being movably coupled to said actuator.

6. The assembly of claim 1, further comprising said trailer speed sensor comprising:
a wheel speed sensor positioned proximate a wheel of the trailer; and
a receiver coupled to said actuator, said wheel speed sensor being communicatively coupled to said receiver.

7. The assembly of claim 1, further comprising said wheel speed sensor being wirelessly communicatively coupled to said receiver.

8. The assembly of claim 1, further comprising said threshold speed being between 15 and 25 miles per hour.

9. The assembly of claim 1, further comprising said threshold speed being 20 miles per hour.

10. A trailer safety assembly comprising:
an actuator coupled to a trailer such that said actuator is positioned in a static position relative to and proximate a king pin on the trailer, said actuator being coupled to a bottom wall of the trailer wherein said actuator extends upwardly into the bottom wall of the trailer wherein a bottom of said actuator is positioned below a bottom surface of the bottom wall of the trailer, said actuator being positioned closer to the king pin than a rear of the trailer;
a pin operationally coupled to said actuator wherein said pin is selectively extendable from said trailer to engage a fifth wheel on a vehicle, said pin being centrally positioned with respect to a first lateral side and a second lateral side of the trailer, said pin being movably coupled to said actuator such that said pin is positionable in an extended position when said actuator is activated wherein said pin is extended downwardly away from said trailer past a bottom of said actuator to position said pin within a tapered slot of a king pin space of said fifth wheel on said vehicle such that said pin is restricted by opposite edges defining said tapered slot of said king pin space of said fifth wheel and pivoting of said trailer about said king pin relative to said fifth wheel is inhibited, said pin being positionable in a retracted position when said actuator is deactivated wherein said pin retracts wherein a bottom of said pin is positioned clear of said fifth wheel to allow free pivoting of said trailer relative to said fifth wheel; and
a trailer speed sensor operationally coupled to said actuator, said wheel speed sensor being configured for detecting a speed of said trailer, said trailer speed sensor activating said actuator to extend said pin when said trailer is traveling faster than a threshold speed, said trailer speed sensor deactivating said actuator wherein said pin is retracted when said trailer is traveling slower than said threshold speed, said threshold speed being between 15 and 20 miles per hour, said trailer speed sensor comprising a wheel speed sensor positioned proximate a wheel of the trailer, and
a receiver coupled to said actuator, said wheel speed sensor being communicatively coupled to said receiver, said wheel speed sensor being wirelessly communicatively coupled to said receiver.
